(19) United States
(12) Patent Application Publication
(10) Pub. No.: US 2022/0362079 A1
(43) Pub. Date: Nov. 17, 2022

(54) MULTIFUNCTIONAL MEDICAL BED

(71) Applicant: «Papillon» Limited liability company, Moscow (RU)

(72) Inventors: Pavel Andreevich ANTONOV, Novosibirsk (RU); Igor Vadimovich MENDZEBROVSKII, Moskovskaya (RU); Vadim Gennadevich POVETKIN, Kaluzhskaya (RU)

(21) Appl. No.: 17/435,366

(22) PCT Filed: Jul. 23, 2021
(86) PCT No.: PCT/RU2021/000313

§ 371 Date: Aug. 31, 2021

(30) Foreign Application Priority Data
Jan. 29, 2021 (RU) 2021102044

(51) Int. Cl. A61G 7/015; A61G 7/05

(52) U.S. Cl. CPC A61G 7/015; A61G 7/0507

(57) ABSTRACT

A multifunctional medical bed that can be used to care for patients who are required to periodically change their body position. The claimed multifunctional medical bed solves the problem of creating a bed with the possibility of safe movement of the patient and his or her positioning into a prone position in combination with functions for the prevention of pulmonological and cardiovascular complications associated with immobility of the patient.

### FIELD OF THE INVENTION

The invention relates to medical equipment and can be used to care for patients in need of periodic changes in body position. In particular, it refers to beds for nursing patients after surgery, trauma, and other patients in need of periodic changes in the position of the body in space.

### STATE OF THE ART

From the prior art, a technical solution is known according to the patent No. RU2019165 for the invention “Hospital bed” (application: 4955016/14, publication date: 15 Sep. 1994, IPC: A61G 7/10), disclosing a hospital bed comprising a frame base with wheels, a couch in the form of articulated chest, hip and leg sections, a mattress in the form of separate blocks and a drive in the form of two hinged parallelograms, each of which is connected to the chest and leg sections being configured to rotate them simultaneously in opposite directions wherein, in order to improve ease of use by raising the couch and transferring it to a vertical position while maintaining a stable position of the patient, the bed is equipped with means for attaching the patient to the couch in the form of chest, waist and groin straps hinged to the chest section and an additional drive in the form of three telescopically mounted screws wherein one end screw is pivotally mounted to the base, and the other end screw is pivotally connected through a gear train to one of the U-shaped racks pivotally connected to the hip section and to the base of the racks, wherein the articulated parallelograms of the main drive are interconnected by means of axes, one of which is kinematically connected to the screw pair, and one of their segments is made in the form of armrests, wherein the chest strap is connected to the chest section through axillary stops, and the groin straps are equipped with a groin stop that can be connected to one end of the lever, the other end of which is hinged on the couch.

However, said analogue is not capable to provide the technical result, which consists in the safe movement of the patient, namely, in the movement to a prone position or a number of positions requiring the patient to be turned over, for example, on his or her side. The disadvantage of this technical solution is, firstly, the lack of division of the couch into two separate segments, and secondly, the absence of appropriate drive mechanisms that could ensure the movement of the separate segments from side to side, including due to the possibility of separate control. Thirdly, the presented analogue is not able to carry out movements in the horizontal longitudinal axis of rotation and change the height of the couch. This technical solution has limited functionality of movement and does not provide the possibility of free, safe movement of the patient in the bed.

From the prior art, a technical solution is known according to the patent No. RU2603580 for the invention “Kinetic bed” (application: 2015145906/12, publication date: 27 Nov. 2016, IPC: A61G 7/015), disclosing a kinetic bed comprising a frame base, a support surface consisting of at least four longitudinal sections and connected to the base through mechanisms for rotating the support surface about the longitudinal central axis and mechanisms for changing the planar position of the support surface, wherein each of the sections of the support surface is connected to the adjacent section being configured to rotate longitudinally relative to each other and comprises at least one drive mechanism for rotating thereof, while the central sections of the support surface are made two-level, wherein the upper level of each of them comprises at least three transverse parts configured to longitudinal movement and transverse raising/lowering.

However, this analogue is also not capable to provide the technical result, which consists in the safe movement of the patient, namely, the proposed design does not allow lowering the patient's lower legs relative to the femoral region (in particular, in the position of “cardiac chair”) without longitudinal movement of the upper level of the support surface central sections, which leads to displacement of the patient and possible dislocation (movement/displacement) of drainage, infusion, transfusion and breathing tubes in the patient's body, and there is also a risk that the person will fall (roll) from the central part when moving to a sitting position because there is no passive support for the feet.

From the prior art, a technical solution is known according to the application No. JP2010-140086 for the invention “BED AND WHEEL CHAIR” (priority date: 21 Jun. 2010, IPC: A61G 7/00, A61G 1/02, A61G 5/02). The analogue is a bed configured to transform into a chair. Two frames are static relative to each other, with a couch located on the upper frame. The couch consists of 5 interconnected segments.

However, this analogue is also not capable to provide the technical result, which consists in the safe movement of the patient, namely, in the movement to a number of positions, for example, the Trendelenburg and anti-Trendelenburg position, and it is also impossible to provide changing the height of the entire couch as well as turning the patient over to a prone position. The disadvantage of this technical solution is the absence of intermediate frames and corresponding drive mechanisms that could provide rotation about the longitudinal axis of rotation of the bed while maintaining the possibility of changing the position of the sections of the couch, as well as changing the height of the intermediate frames.

From the prior art, a technical solution is known according to the patent No. RU2293547 for the invention “Hospital bed (options)” (application: 2005107916/14, publication date: 20 Feb. 2007, IPC: A61G 7/015), disclosing a hospital bed comprising a frame with self-orienting wheels mounted on vertical racks, and a couch consisting of movable sections located on the frame and having a drive, wherein the couch has at least three movable sections with lever drive supports and at least one fixed section, wherein the frame is made in the form of a truss having the form of a parallelepiped, the corners of the ribs of which are connected to the vertical racks by fastening pipes, and the drive is made in the form of mechanical, or pneumomechanical, or hydromechanical, or electric power telescopic working elements with control levers for a standing person, which are located at the end of the couch, and with parallel connected lever controls for a person lying on the couch, which are located in an accessible place or accessible places, wherein the ends of at least one telescopic working element are pivotally connected to the drive lever supports of at least two movable sections and the ends of at least two telescopic working elements are pivotally connected to the frame and to the lever drive supports of the movable sections installed at the ends of the fixed section.

However, this analogue is also not capable to provide the technical result consisting in the safe movement of the patient, namely, in moving to a number of positions, for example, the Trendelenburg and anti-Trendelenburg position, and it is also impossible to ensure changes in the height of the entire bed and turning the patient to a prone position. The disadvantage of this technical solution is the absence of intermediate frames and corresponding drive mechanisms that could provide rotation about the longitudinal axis of rotation of the bed while maintaining the possibility of changing the position of the bed sections, as well as changing the height of the intermediate frames.

From the prior art, a technical solution is known according to the application No. ES2010070332W for the invention “INTELLIGENT HOSPITAL BED AND METHOD FOR OPERATING SAME” (priority date: 18 May 2010, IPC: A61G 7/015, A61G 7/10, A61G 7/018, A61G 7/008, A61B 5/103, A47C 20/04). The analogue is a multifunctional bed, consisting of two frames and one couch. The couch consists of 4 sections. The upper frame and couch are driven by drive mechanisms.

However, this analogue is also not capable to provide the technical result, which consists in the safe movement of the patient, namely, in the safe movement to a prone position. The disadvantage of this technical solution is the absence of at least two intermediate frames and corresponding drive mechanisms that could provide rotation about the longitudinal axis of rotation of the bed while maintaining the possibility of changing the position of the sections of the couch. In the analogue presented, the bed is tilted entirely. Therefore, the patient will roll over much more slowly, and at the end of the roll-over will continue to roll, since the entire plane is tilted, which may entail the risk of getting or aggravating the trauma of the person and causing pain in the patient.

The closest analogue is the patent No. RU2692898 for the invention “Multifunctional bed” (application: 2018142882, publication date: 28 Jun. 2019, IPC: A61G 7/005, A61G 7/012, A61G 7/015, A47C 19/00) disclosing a multifunctional bed comprising a lower frame with two X-shaped frame aims pivotally mounted thereon at an angle to each other, which are not connected to each other, an upper intermediate frame hinged on the frame arms, which upper frame is installed and configured to rotate relative to a horizontal plane at an angle from −25° to 90° by means of actuators, a tilting mechanism and a couch fixed on the upper frame through an intermediate frame, the couch consists of five sections, three of which are installed and configured to rotate by means of actuators at an angle from 0° to 90° relative to the fixed section and the intermediate frame, wherein cutouts are made in three sections of the couch for installing the tilting mechanism having levers with rollers, which are configured to rotate simultaneously about the longitudinal axis of the bed by means of the actuator.

The disadvantage of this technical solution is the absence of at least two intermediate frames and corresponding drive mechanisms that could provide rotation about the longitudinal axis of rotation of the bed while maintaining the possibility of changing the position of the couch sections. That is, there is completely no possibility of turning a person over, including into a prone position. This analogue comprises cutouts made in three sections of the couch for installing the tilting mechanism having levers with rollers, which are configured to rotate simultaneously about the longitudinal axis of the bed by means of the actuator. However, such a design significantly complicates the process of operating the device, and also seems to be difficult to implement with the condition of maintaining the safety of the patient, since based on the published drawings of the analogue, in the case of raised sides to ensure safety, there is little space for free and unhindered turning the person over.

### SUMMARY OF THE INVENTION

The claimed technical solution is aimed at solving the problem of developing a bed configured to safe movement of the patient and his or her transfer to a prone position in combination with functions for the prevention of pulmonological and cardiovascular complications associated with patient's immobility.

The technical result, which makes it possible to solve this problem, consists in the safe movement of the patient in the bed without the use of physical force of a person, including moving to a prone position, to a sitting position, and to a lateral position.

The technical result is achieved due to the fact that a multifunctional bed consists of a bed base frame connected to a couch base frame, two couches installed on the couch base frame, with two lower leg sections, two thigh sections, two hip sections, and two back sections attached to the couches. In this case, the change in the height of the couch base frame, the rotation of the couch base frame about the longitudinal and transverse axes of rotation are carried out by means of three basic drive mechanisms installed on the couch base frame, wherein additional drive mechanisms are installed on the couch base frame to rotate the couches about the longitudinal axis of rotation relative to each other, the lower leg sections are configured to turn below the horizontal axis of the couches while maintaining the position of the couch base frame, and the hip sections are fixed, wherein each section is configured to change the position by means of the section drive mechanism, independently of other drive mechanisms of other sections.

An embodiment is possible in which two couches are connected to the couch base frame by articulated connections located in the central part of the couch base frame.

An embodiment is possible in which the basic drive mechanisms are made in the form of actuators having three lifting arms with hinged joints. In this case, the hinged joints are located at an angle to the bed base frame.

It is possible to connect the bed base frame to the couch base frame directly by means of three basic drive mechanisms. In this case, the basic drive mechanisms are made in the form of electric columns.

Additionally, main rails consisting of at least two panels can be mounted on the two couches. One panel of the main side rail can be mounted on the back section.

In addition, the multifunctional bed can comprise additional foldable side rails.

Sliding wheels can also be used on which the bed base frame is mounted.

### DESCRIPTION OF THE DRAWINGS

The subject matter of this application is described point by point and clearly stated (described) in the claims. The foregoing objects, features and advantages of the invention will be apparent from the following detailed description in connection with the accompanying drawings, in which:

FIG. 1 shows a multi-functional bed with lifting arms;

FIG. 2 shows a multifunctional bed with electric columns;

FIG. 3 shows a multifunctional bed with sections (top view);

FIG. 4 shows a multifunctional bed in the position when the “bicycle” function is activated;

FIG. 5 shows a gear train of the main side rails;

FIG. 6 shows a multifunctional bed in a “cardiac chair” position;

FIG. 7 shows a multifunctional bed with additional side rails;

FIG. 8a shows block diagram of the steps of raising and lowering the couch base frame.

FIG. 8b shows block diagram of the steps of rotation of the couch base frame about the longitudinal axis of rotation;

FIG. 8c shows block diagram of the steps of rotation of the couch base frame in the transverse axis of rotation;

FIG. 8d shows block diagram of the steps of rotation of the couches about the longitudinal axis of rotation relative to each other.

These figures are explained by the following positions: 1 is a multifunctional bed, 2 is a bed base frame, 3 is a lifting arm, 4 is a drive mechanism (actuator), 5 is a couch base frame, 6 is a couch, 7 is a pair of sliding wheels, 8 are systems of levers for moving the couches, 9 is a hinged joint between the bed base frame and the lifting arms, 10 are electric columns, 11 is the main side rail (leg), 12 is the main side rail (central), 13 is the main side rail (head), 14 is a hinged joint between the couches and the couch base frame, 15 are additional drive mechanisms, 16 is hinged joint for movement of sections, 17 are section drive mechanisms, 18 is a lower leg section, 19 is a thigh section, 20 is a hip section, 21 is a back section, 22 are foot stops, 23 is a drive mechanism for movement of the main side rails (central), 24 is an articulated connection of side rails and couches, 25 is a gear train of the main side rail, 26 is a hinged joint between the bed base frame and the actuator, 27 is a hinged joint between the lifting arm and the actuator, 28 is a hinged joint between the couch base frame and the actuator, 29 is an additional side rail, 30-37 are described in the text below.

### DETAILED DESCRIPTION OF THE INVENTION

In the following detailed description of the invention, numerous implementation details are set forth to provide a thorough understanding of the present invention. However, it will be obvious to those skilled in the art how the present invention can be used, with or without these implementation details.

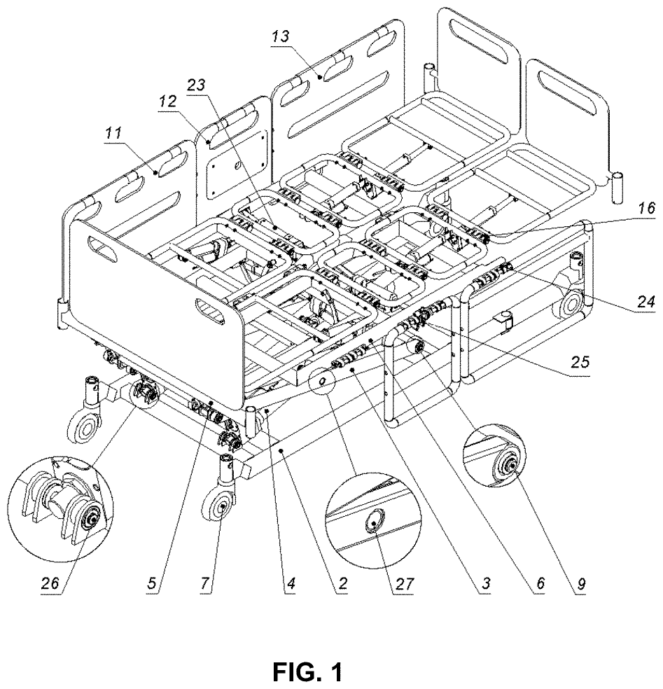

FIG. 1 shows a multifunctional bed (1) designed to move a patient in the bed without the use of human physical force, the bed comprises a bed base frame (2), lifting arms (3), drive mechanisms in the form of actuators (4), a couch base frame (5), and two couches (6). Also FIG. 1 shows the main side rail with leg (11), central (12), and head (13) panels.

Bed Base Frame

The bed base frame (2) may comprise at least one pair of sliding wheels (7) to ensure the stability of the structure. It also allows the bed to be moved in any direction. The wheels (7) are moved apart by drive mechanisms, which are also installed on the bed base frame (2), increasing the support area when the bed is stationary.

Drive Mechanisms and Lifting Arms

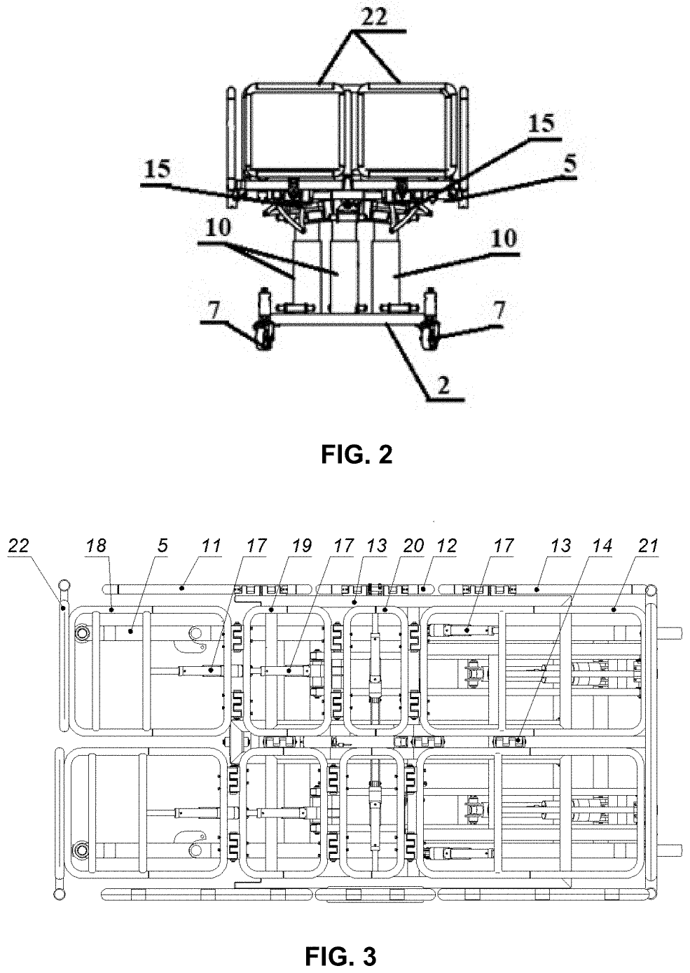

FIG. 1 shows one of the embodiments of the invention where the couch base frame (5) is moved by three basic drive mechanisms (4). The use of three basic drive mechanisms (4) ensures the inclination of the couch base frame (5) along two axes: longitudinal to the left and to the right for lateral inclination, as well as transverse. Actuators (an actuating device with or without a motor, which is electromechanical or mechanical, controlled by a control device) (4) or electric columns (10) of FIG. 2 can be used as basic drive mechanisms (4).

In one embodiment, when using actuators (4) as basic drive mechanisms, lifting arms (3) are used. In this case, the lifting arms (3) are mounted on the bed base frame (2). Hinged joints (9) are installed at the points of attachment of the lifting arms (3) to the bed base frame (2). Each lifting arm (3) is capable of performing movement without engaging (driving) the remaining lifting arms (3), which makes it possible to rotate the couch base frame (5) about the longitudinal and transverse axes. Any type of lifting arms (3) can be used, including composite and solid ones. The lifting arms (3) are located at an angle to the bed base frame (2), which allows a smooth change in the position of the couch base frame (5) relative to the longitudinal and transverse axes. The actuators (4) are installed on the bed base frame (2). Hinged joints (26) are installed at the points where the actuators (4) are attached to the bed base frame (2). In this case, one actuator (4) drives one lifting arm (3). Hinged joints (27) are installed at the points of attachment of the actuator (4) to the lifting arm (3). The lifting arms (4) are mounted in a scissor-to-cross pattern. This arrangement of the lifting arms (4) on the bed base frame (2) is due to the fact that this combination makes it possible to evenly distribute the load on the lifting arms (4) and achieve the stated technical results of the bed.

In one of the embodiments, electric columns (10) are used as the basic driving mechanisms. This embodiment is shown in FIG. 2. The electric columns (10) make it possible to avoid use of lifting arms.

The basic drive mechanisms (4, 10) can be configured to actuate (open or close) an individual drive mechanism (4, 10), without involving the rest of the basic drive mechanisms (4, 10) of the bed, which expands the possibilities for the motion of the bed couch base frame, in particular, contributes to the inclination of the couch base frame (5) relative to the longitudinal and transverse axes, movement along the vertical axis.

Couch Base Frame

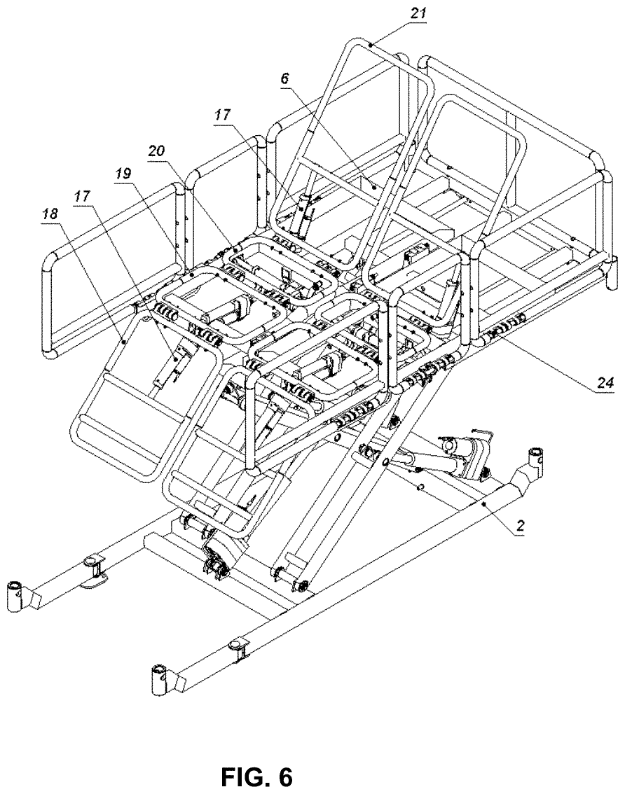

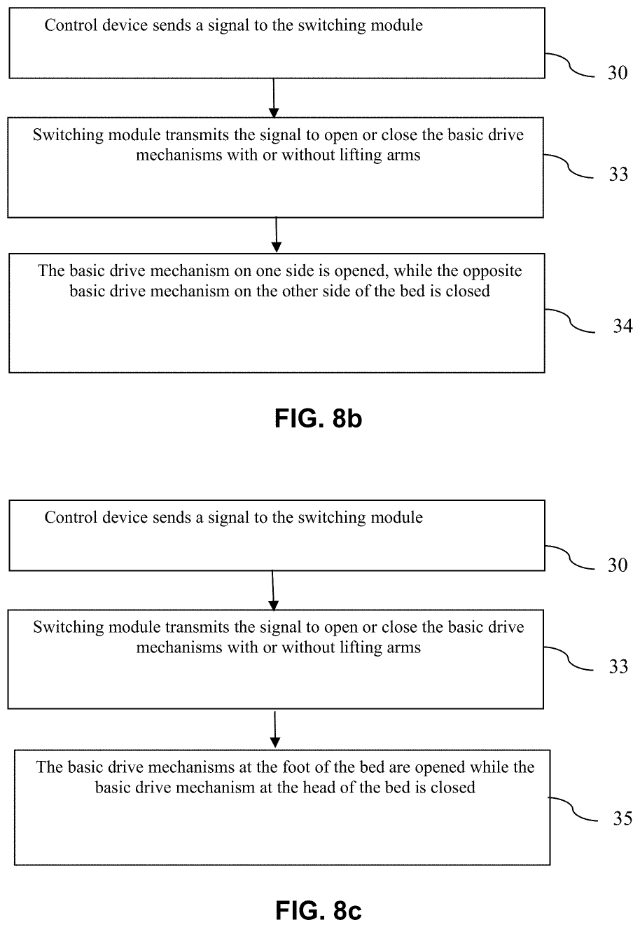

The couch base frame (5) can be mounted on lifting arms (3) as shown in FIG. 1. In this case, at the attachment points of the three lifting arms (3) to the couch base frame (5) hinged joints (28) are used, as shown in FIG. 4. Also, the couch base frame can be mounted on the electric columns (10), as shown in FIG. 2, using articulated connections. The couch base frame (5) serves to install two couches (6) thereon, wherein each couch comprises: three rotatable main side rails (11, 12, 13), one foldable additional side rail (29) of FIG. 7 and a drive mechanism (23) for the movement of three main side rails. There are also additional drive mechanisms on the couch base frame that ensure the movement of both couches (15). The couch base frame (5) is capable of rotating about the longitudinal axis of rotation in the angular range from −20° to 20°, and about the transverse axis of rotation in the angular range from −35° to 35°.

Two Couches

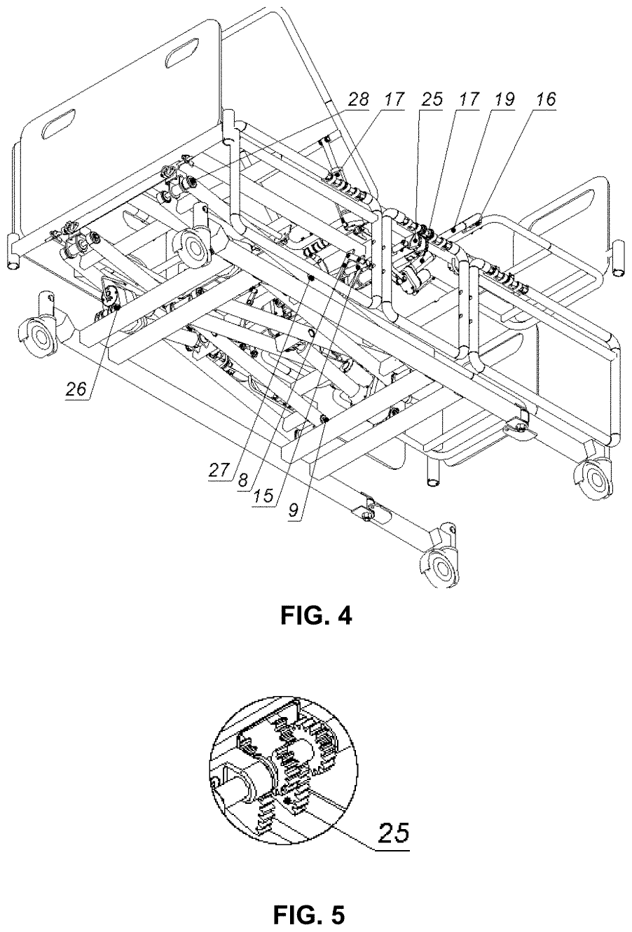

FIG. 3 shows a multifunctional bed comprising two couches (6) installed on the couch base frame (5). Both couches (6) comprise hinged joints (14) at the points of attachment to the couch base frame (5), which are located in the central part of the couch base frame. The couches (6) are installed in such a way that they can rotate about the longitudinal axis of the bed, from 0° to 85° in the opposite direction. The rotation is carried out by an additional drive mechanism for the movement of the couches (15), located on the couch base frame (5), and a system of levers (8), as shown in FIG. 4. This contributes to the achievement of the technical result, which consists in moving the patient in the bed without using the physical force of a person, including moving to a prone position.

Movable Sections of the Multifunctional Bed

The multifunctional bed sections are used to change the position of the lower leg (tibia and fibula), femur and back. The claimed multifunctional bed has 8 sections: two symmetrical lower leg (18), two symmetrical thigh (19), two symmetrical hip (20), and two symmetrical back (21) sections. The lower leg (18), thigh (19), and back (21) sections are movable and comprise hinged joints (16). The lower leg (18) section is connected through a hinged joint (16) to the thigh section (19). The thigh section (19) is connected through a hinged joint (16) to the fixed hip section (20). The fixed hip section (20) is connected through a hinged joint (16) to the back section (21).

The lower leg sections (18) do not rest on the couch, which allows the bed to be placed in “cardiac chair” mode without moving all sections of the bed forward. Therefore, a person is moved to the “cardiac chair” position with a minimum set of actions. The hip sections (20) are fixed relative to the movable sections, since the hip sections (10) are parts of the assemblies of the left and right couches (6) frames. The thigh (19) and back (21) sections are mounted on the couches (6). The location of the lower leg (18), thigh (19), hip (20), and back (21) sections is shown in FIG. 3.

To ensure the angle of raising/lowering of the movable sections (18, 19, 21) relative to the couches, the drive mechanisms (17) of the sections are used. The lower leg sections (18) are moved by opening/closing the drive mechanisms (17) for the movement of the sections installed and resting on the thigh sections (19). The thigh sections (19) are moved by opening/closing the drive mechanisms (17) for the movement of the sections installed and resting on the couches (6). The back sections (21) are moved by opening/closing the drive mechanisms (17) for the movement of the sections, installed and resting on the couches (6). All drive mechanisms (17) for the movement of the sections have hinge joint (16) at the points of attachment to the lower leg (18), thigh (19), and back (21) sections or couches (6).

The lower leg sections (18) are equipped with foot stops (22). The foot stops (22) are necessary to support the patient's feet and have a manual analog (smooth) mechanism or drive mechanisms (actuators) for adjusting the length of the panel overhang

Main Side Rails

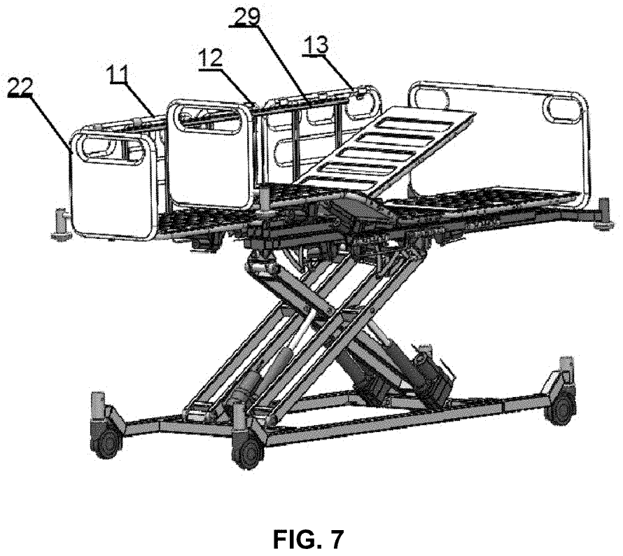

On one side of each couch (6), rotatable main side rails (11, 12, 13) are mounted by means of articulated connections (24) through a gear train (25), which makes it possible to change the angle between the main side rails (11, 12, 13) and couches (6) from 90° to 270°. The gear train is shown in FIG. 5. The movement of the couches is possible not only using the gear train, but also using lever mechanisms, etc. It is possible to use two main side rails, one of which is attached to the back section. Changing the angle makes it possible to adjust the bed space with an orientation to the patient's size, ensures safety during transportation, and is an integral part of the patient turning mechanism. The main side rails (11, 12, 13) consist of central panels (12) with drive mechanisms for the movement of the side rails (23), and also of head side panels (13) and leg side panels (11) without drive mechanisms. The head (13) and foot (11) panels are configured to rigid connection with the central panel (12), which allows changing the angle between all sections and couches (6) simultaneously.

Additional Side Rails

FIG. 7 shows the multifunctional bed with additional side rails (29), which are used as a lever to move the patient across the mattress by pulling the sheet. In this case, the sheet is thrown over the additional side rails (29) and fixed on the main side rails (11, 12, 13). The main side rails (11, 12, 13) are moved to a position where the angle between the main side rails and the couch is 270°. By means of which the sheet is pulled, thrown over the additional side rails (29), and the patient is pulled up, sliding on the sheet over the mattress, towards one side of the bed. Foldable additional side rails are mounted on the couch frame by means of bolt connections.

Drive Mechanism Control Device

The drive mechanisms (4, 10, 15, 17, 23) are actuated using a control device such as a remote control device. The main remote control device is managed by the medical staff, auxiliary device is managed by the patient. If the remote control device fail, the drive mechanisms (4, 10, 15, 17, 23) are controlled by a controller using a switching module according to the algorithm specified by the program. It is possible to reboot the electronic system, in the event of errors in operation, using the control device and controller, when the drive mechanisms (4, 10, 15, 17, 23) are brought to the initial (zero) position, in which all sections are in horizontal position, the main side rails (11, 12, 13) are located in the “up” position, and the height of the couch (6) is set in the range from 450 to 1000 mm from floor level. Power supply and battery recharging are performed through a cable from a standard power outlet. An electronic panel can be used as the control device.

Procedure for Section Position Change

The movement of the couch base frame, the couches themselves and the sections of the bed to move the patient is carried out as follows:

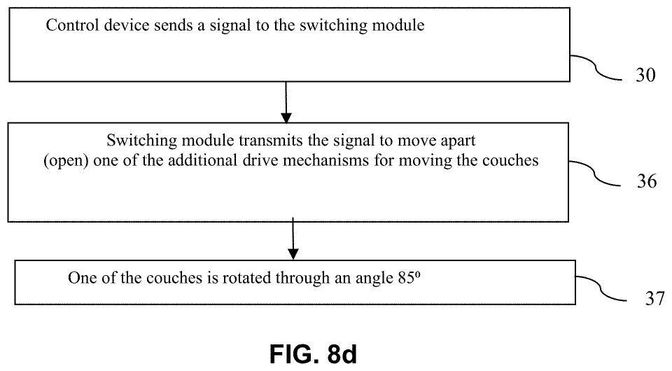

FIG. 8a shows block diagram of the steps of raising and lowering the couch base frame, which are performed as follows: the control device sends a signal to the switching module (30). The switching module transmits the signal to move apart (open) the basic drive mechanisms (4, 10), with (3) or without (31) lifting arms, in case of raising or to move them together (close) in case of lowering. The basic drive mechanisms are opened/closed at the same speed, synchronously and in the same direction (32).

FIG. 8b shows block diagram of the steps of rotation of the couch base frame about the longitudinal axis of rotation, which are performed as follows: the control device sends a signal to the switching module (30). The switching module transmits the signal to open or close the basic drive mechanisms (4, 10), with (3) or without (33) lifting arms. The drive mechanism on one side is opened, while the opposite drive mechanism on the other side of the bed is closed. In this case, the basic drive mechanisms (4, 10) are moved apart (opening)/moved together (closing) at the same speed, asynchronously and in different directions (34).

FIG. 8c shows block diagram of the steps of rotation of the couch base frame in the transverse axis of rotation, which are carried out as follows: the control device sends a signal to the switching module (30). The switching module transmits the signal to move apart (open)/move together (close) the basic drive mechanisms (4, 10) in the leg of the bed in one direction, and, if necessary, simultaneously move apart (open)/move together (close) the drive mechanism (4, 10) in the head of the bed in the opposite direction (35), which mechanisms are located between the bed base frame (2) and the couch base frame (5). In this case, the basic drive mechanisms (4, 10) are moved apart (opening)/moved together (closing) at the same speed, asynchronously and in different directions (34).

FIG. 8d shows block diagram of the steps of rotation of the couches about the longitudinal axis of rotation relative to each other, which are carried out as follows: the control device sends a signal to the switching module (30). The switching module transmits the signal to move apart (open) one of additional drive mechanisms (36) for movement of the couches (15), fixed on the couch base frame (5), to one of the couches (6). One of the couches (6) is rotated through an angle of 85° (37).

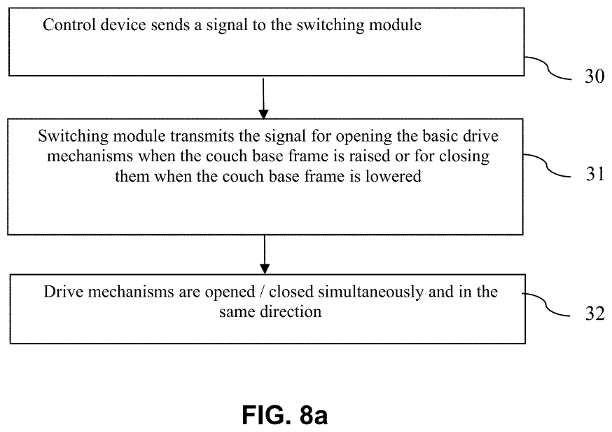

When activating the “cardiac chair” function from the operator's control device or from the patient's control device, the switching module transmits the signal to move apart (open) the drive mechanisms of the back section (21) installed on the couch (6), and to move together (close) the drive mechanisms of the lower leg section (18) installed on the couch (6). The drive mechanisms of the back and lower leg sections work in parallel and take a position according to a programmed command, namely, transferring a person to a sitting position with a raised back section (21) and a lowered leg section (18). The position of the “cardio chair” is shown in FIG. 6.

When the “cardiac resuscitation” function is activated from the operator's control device or mechanically, the sections installed on the couches (6), if they were raised/lowered, take a horizontal position by moving apart/moving together the drive mechanisms of the corresponding sections of the couches (6). The basic drive mechanisms (4, 10), with or without lifting arms (3), lower the couch base to a height of 450 mm (minimum couch height).

When the “Fowler” function is activated from the operator's control device or from the patient's control device, the switching module sends the signal to move apart (open) the drive mechanisms of the back sections (21) installed on the couches (6), while the range of adjustment of the tilt angle of the back section of the couch ranges from 45 to 60°. The back section (21) is in the raised position.

When the “bicycle” function is activated from the operator's control device, the switching module transmits a signal to move apart (open) one drive mechanism of the thigh section (19) installed on one couch (6). The corresponding thigh section (19) is rotated up to an angle of 20°. In this case, the thigh section (19), the drive mechanism of which is not involved, is in a horizontal position. At the same time, a signal is sent to move together (close) one drive mechanism of the lower leg section on the same side (18). The corresponding lower leg section (18) is rotated through an angle that ensures that the section is always horizontal. When reaching the end position of the involved thigh section (19) for the “bicycle” function, the engaged drive mechanism of the thigh section (19) is stopped and begins to reverse until the involved thigh section (19) returns to a horizontal position. In this case, the lower leg section (18) remains in a horizontal position due to the return stroke of its drive mechanism. Then these operations are repeated for the previously unused thigh (19) and lower leg (18) sections. The thigh (19) and lower leg (18) sections are raised alternately during the “bicycle” function. The position occupied when the “bicycle” function is activated is shown in FIG. 4. By mechanically changing the position of the limbs, the “bicycle” function allows the preventive measures against vascular complications, muscle atrophy to be taken.

A dynamic system that changes the couch of the bed and a massage system make it possible to prevent pressure ulcers; facilitate medical and diagnostic manipulations for the patient, including radiography of the chest cavity organs in frontal and lateral projections; allow safely transporting the patient to any hospital room. Due to regular changes in body position (lateral tilt, turning over on the belly), it is a means of treating pulmonary complications resulted from prolonged horizontal position of the patient;

In the present application materials, a preferred disclosure of the implementation of the claimed technical solution is presented, which should not be used as limiting other, particular embodiments of its implementation, which do not go beyond the claimed scope of legal protection and are obvious to specialists in the relevant field of art.

We claim:

1. A multifunctional bed comprising:
a bed base frame connected to a couch base frame,
two couches installed on the couch base frame,
two lower leg sections, two thigh sections, two hip sections, and two back sections attached thereto, wherein
the change in the height of the couch base frame, the rotation of the couch base frame about the longitudinal and transverse axes of rotation are carried out by means of three basic drive mechanisms mounted on the bed base frame,
additional drive mechanisms are mounted on the couch base frame to rotate the couches about the longitudinal axis of rotation relative to each other,
the lower leg sections are configured to rotate below the horizontal axis of the couches,
the hip sections are fixed,
the sections are configured to change the position by means of the movable section drive mechanism, independently of the drive mechanisms of other sections.

2. The multifunctional bed according to claim 1, wherein the two couches are connected to the couch base frame by articulated connections located in the central part of the couch base frame.

3. The multifunctional bed according to claim 1, wherein the basic drive mechanisms are made in the form of actuators having three lifting arms with hinged joints.

4. The multifunctional bed according to claim 3, wherein the lifting arms are angled to the bed base frame.

5. The multifunctional bed according to claim 1, wherein the direct connection of the bed base frame to the couch base frame is provided by three basic drive mechanisms.

6. The multifunctional bed according to claim 5, wherein electric columns are used as the basic driving mechanisms.

7. The multifunctional bed according to claim 1, wherein the main side rails are mounted on two couches.

8. The multifunctional bed according to claim 7, wherein each main side rail consists of at least two panels.

9. The multifunctional bed according to claim 8, wherein at least one main side rail panel is mounted on the back section.

10. The multifunctional bed according to claim 1, wherein the bed further comprises foldable additional side rails.

11. The multifunctional bed according to claim 1, further comprising sliding wheels on which the bed base frame is mounted.

12. A method of using multifunctional bed comprising a bed base frame connected to a couch base frame, two couches installed on the couch base frame and connected to the couch base frame, two lower leg sections, two thigh sections, two hip sections, two back sections, basic drive mechanisms, additional drive mechanisms, and section drive mechanisms, wherein:
a control device is used to transmit a signal to a switching module,
the signal from the switching module is transmitted to one or more drive mechanisms,
the drive mechanisms are opened and/or closed,
wherein
change in the height of the couch base frame, the rotation of the couch base frame about the longitudinal and transverse axes of rotation are carried out by means of three basic drive mechanisms installed on the bed base frame,
rotation of the couches about the longitudinal axis of rotation relative to each other is carried out using the additional drive mechanisms,
position of each section is changed using the section drive mechanisms, independently of other drive mechanisms of other sections,
rotation of the lower leg sections below the horizontal axis of the couches is carried out while maintaining the position of the couch base frame.

13. The method of using the multifunctional bed according to claim 12, wherein the couch base frame is additionally rotated about the longitudinal axis of rotation by opening the basic drive mechanism on one side of the bed, while simultaneously closing the basic drive mechanism on the other side of the bed.

14. The method of using the multifunctional bed according to claim 12, wherein the couch base frame is additionally rotated in the transverse axis of rotation by opening the basic drive mechanisms in the leg of the bed while closing the basic drive mechanism in the head of the bed.

15. The method of using the multifunctional bed according to claim 12, wherein the couch is additionally rotated about the longitudinal axis of rotation by opening an additional drive mechanism.

16. The method of using the multifunctional bed according to claim 12, wherein the sections are additionally rotated by opening or closing section drive mechanisms.
